(19) United States
(12) Patent Application Publication
(10) Pub. No.: US 2018/0223591 A1
(43) Pub. Date: Aug. 9, 2018

(54) VEHICLE DOOR, IN PARTICULAR A SLIDING VEHICLE DOOR

(71) Applicant: GÜNTHER TRÖSTER E.K., Breitengüssbach (DE)

(72) Inventor: Günther TRÖSTER, Breitengüssbach (DE)

(21) Appl. No.: 15/750,438

(22) PCT Filed: Jul. 21, 2016
(86) PCT No.: PCT/EP2016/067392

§ 371 Date: Feb. 5, 2018

(30) Foreign Application Priority Data
Aug. 6, 2015 (DE) 20 2015 104 120.9

(51) Int. Cl. E06B 3/70; E06B 3/46; E05D 15/06; B60J 5/06; B60R 13/02; B60J 5/04

(52) U.S. Cl. CPC E06B 3/70; E06B 3/4636; E06B 3/7015; E05D 15/0621; B60J 5/06; B60R 13/0243; E05F 15/70; B60J 5/0437; B60J 5/0469; B60J 5/0481; E06B 2003/7023; E06B 2003/7049; B60J 5/0452

(57) ABSTRACT

The invention relates to a vehicle door, in particular a sliding vehicle door, comprising an inner plastic moulded part, in particular reinforced, and oriented towards the vehicle interior and an outer plastic moulded part, in particular reinforced, oriented away from the vehicle interior. The inner plastic moulded part and the outer plastic moulded part are interconnected for forming the vehicle door.

The invention relates to vehicle doors, in particular sliding vehicle doors. The doors in question here are preferably side doors of vehicles.

Such vehicle doors are used, for example, in automobiles, vans or on the sides of small delivery trucks. Such vehicle doors have to meet the following requirements, in particular: straightforward production, cost-efficient production, high safety levels, for example in the event of an accident, and low weight, in particular in respect of energy efficiency.

The object of the invention is therefore to specify a novel vehicle door, in particular a vehicle door which at least for the most part meets these requirements.

This object is achieved by the features of claim 1. Advantageous configurations and developments are specified in the respectively dependent claims.

The vehicle door according to the invention comprises an in particular reinforced, inner plastic molding, which is oriented in the direction of the vehicle interior, and an in particular reinforced, outer plastic molding, which is oriented away from the vehicle interior, wherein the inner plastic molding and the outer plastic molding are connected to one another to form the vehicle door.

The advantages of the invention reside, in particular, in that the vehicle door according to the invention gives rise to a considerable improvement in the side-impact behavior and, in addition, weight is reduced to a great extent. The reduction in weight here is 30% and more in relation to known solutions.

The vehicle door particularly preferably has a plastic content equal to at least 75% of the overall volume or at least 75% of the overall mass.

According to an advantageous development of the invention, the inner plastic molding and/or the outer plastic molding are/is reinforced by additives, for example fibers, and/or by shaping, for example the provision of beads and/or ribs.

According to an advantageous development of the invention, a reinforcement can be provided between the inner and the outer plastic moldings, wherein the reinforcement is formed from metal and/or from fiber-reinforced plastic, wherein the reinforcement is connected to the inner plastic molding and/or the outer plastic molding preferably by adhesive bonding and/or welding and/or screw connection and/or clip connection.

The inner plastic molding and the outer plastic molding are preferably connected to one another by adhesive bonding and/or welding and/or clip connection.

Provision may also be made for the vehicle door to have a window made of glass or plastic, for example PMMA (polymethyl methacrylate) or PC (polycarbonate), wherein a window frame and/or a window guide are/is provided, said window frame and/or window guide being formed preferably at least essentially flush with the outer plastic molding.

The vehicle door preferably does not have any window-activating elements, for example any window lifter.

Provision may be made for the window to be coated and/or sprayed with plastic, in particular a plastic provided for forming the outer plastic molding. As an alternative, or in addition, provision may be made for the window to be formed from plastic and to be produced by 2-component injection molding together with the outer plastic molding.

According to a variant of the invention, in order to increase rigidity of the vehicle door, cavities located between the inner plastic molding and outer plastic molding are at least partially packed or filled with foam, wherein for example PU foam is used for packing purposes or is the foam provided.

One embodiment of the invention provides for the vehicle door to be a sliding door which is designed such that it can be displaced in the forward and/or rearward direction on the vehicle for opening purposes.

It is preferably therefore the case that the vehicle door does not have any hinges to provide for pivoting of the door.

According to a preferred and expedient development of the invention, the vehicle door is a sliding door which has at least one guide rail or which is assigned at least one guide rail, wherein the guide rail is, in particular, designed in order for the vehicle door to be displaced on the vehicle in the forward and/or rearward direction into an open position, from a closed position, along a travel path predetermined by the guide rail. The at least one guide rail can be capable of being covered by one or more flaps which can be swung away in particular laterally in relation to the longitudinal extent thereof. In order for the vehicle door to be displaced, the flaps are swung away. Once the vehicle door is located in the desired position, in particular in a closed position, the flaps can be swung over the guide rail again. The closed flaps ensure a better design and/or appearance of the vehicle, furthermore there is an improvement in the flow resistance of the vehicle, in comparison with non-covered guide rails, when the flaps are closed, and in addition closure of the flaps reduces the level of soiling to which the guide rail is subjected.

The guide rail may be provided on the vehicle body, for example on the front or rear fender. It is also conceivable, however, for the guide rail to be provided on the vehicle door. Furthermore, the guide rail may be concealed or covered, in which case, when the vehicle door is closed, it is hidden from view, at least for the most part, for example by the aforementioned flaps.

In order to reduce the coefficients of friction, protuberances, in particular protuberances made of POM (polyoxymethylene), may be provided on the guide rail, preferably by injection molding.

A development of the invention provides for the guide rail to have a plurality of predetermined breaking points, in particular on its rear side. These predetermined breaking points may be designed such that they buckle or yield or rupture in the event of pronounced impact and/or of impact which exceeds a predetermined limit value. The strength of impact, or the predetermined limit value from which the predetermined breaking point reacts to the impact, can be selected at least essentially in accordance with the triggering threshold of an airbag device.

The vehicle door may expediently be designed such that automatic and/or manual opening and closing of the vehicle door of the vehicle is possible.

The vehicle door is preferably a rigid, pared-down (i.e. comprising only a minimal number of necessary components), very lightweight vehicle door.

The invention also relates to a vehicle having a vehicle door according to the invention. The at least one guide rail can then be provided on the body of said vehicle, in particular on the front or rear fender thereof.

1. A vehicle door, in particular a sliding vehicle door, comprising an in particular reinforced, inner plastic molding, which is oriented in the direction of the vehicle interior, and an in particular reinforced, outer plastic molding, which is oriented away from the vehicle interior, wherein the inner plastic molding and the outer plastic molding are connected to one another to form the vehicle door.

2. The vehicle door as claimed in claim 1, characterized in that the vehicle door has a plastic content equal to at least 75% of the overall volume or of the overall mass.

3. The vehicle door as claimed in claim 1, characterized in that the inner plastic molding and/or the outer plastic molding are/is reinforced by additives, for example fibers, and/or by shaping, for example the provision of beads and/or ribs.

4. The vehicle door as claimed in claim 1, characterized in that a reinforcement is provided between the inner and the outer plastic moldings, wherein the reinforcement is formed from metal and/or from fiber-reinforced plastic, wherein the reinforcement is connected to the inner plastic molding and/or the outer plastic molding preferably by adhesive bonding and/or welding and/or screw connection and/or clip connection.

5. The vehicle door as claimed in claim 1, characterized in that the inner plastic molding and the outer plastic molding are connected to one another by adhesive bonding and/or welding and/or screw connection and/or clip connection.

6. The vehicle door as claimed in claim 1, characterized in that the vehicle door has a window made of glass or plastic, for example PMMA or PC, wherein a window frame and/or a window guide is provided, said window frame and/or window guide being formed preferably essentially flush with the outer plastic molding.

7. The vehicle door as claimed in claim 1, characterized in that in order to increase rigidity, cavities located between the inner plastic molding and outer plastic molding are at least partially packed or filled with foam, wherein for example PU foam is used for packing purposes or is the foam provided.

8. The vehicle door as claimed in claim 1, characterized in that the vehicle door is a sliding door which is designed such that it can be displaced in the forward and/or rearward direction on the vehicle for opening purposes.

9. The vehicle door as claimed in claim 1, characterized in that the vehicle door does not have any hinges to provide for pivoting of the door.

10. The vehicle door as claimed in claim 1, characterized in that the vehicle door is a sliding door which has at least one guide rail or which is assigned at least one guide rail wherein the guide rail is, in particular, designed in order for the vehicle door to be displaced on the vehicle in the forward and/or rearward direction into an open position, from a closed position, along a travel path predetermined by the guide rail.

11. The vehicle door as claimed in claim 10, characterized in that the at least one guide rail can be covered by one or more flaps which can be swung away in particular laterally in relation to the longitudinal extent thereof.

12. The vehicle door as claimed in claim 10, characterized in that in order to reduce the coefficients of friction, protuberances, in particular protuberances made of POM (polyoxymethylene), are provided on the guide rail, preferably by injection molding.

13. The vehicle door as claimed in claim 10, characterized in that the guide rail has a plurality of predetermined breaking points, in particular on its rear side.

14. The vehicle door as claimed in claim 1, characterized in that the vehicle door is designed such that automatic and/or manual opening and closing of the vehicle door of the vehicle is possible.

15. A vehicle having a vehicle door as claimed in claim 10.
